(19) United States
(12) Patent Application Publication
(10) Pub. No.: US 2014/0115915 A1
(43) Pub. Date: May 1, 2014

(54) COAT HANGER FOR CONVEYOR BELTS

(71) Applicant: CHRIS YOUNG, Glendale, CA (US)

(72) Inventor: CHRIS YOUNG, Glendale, CA (US)

(21) Appl. No.: 13/666,960

(22) Filed: Nov. 1, 2012

(51) Int. Cl. A47G 25/14; F26B 25/00

(52) U.S. Cl. 34/239; 223/85

(57) ABSTRACT

A Conveyor Belt Coat Hanger for Shirts and other Clothing includes a Hook, a First Member, a Second Member, a Third Member, and a Collar Bar. This Conveyor Belt Coat Hanger for Shirts and other Clothing is used so that a dry cleaning facility can maintain the structural integrity of the collars of the shirts while economizing spatial considerations.

### FIELD OF THE INVENTION

The present invention is in the area of clothing and attendant services and more particularly pertains to a Conveyor Belt Coat Hanger for Shirts and other Clothing for dry cleaning facilities.

### BACKGROUND

The cynosure of any quality dress shirt lies in the collar. The collar, according to many experts can help frame the rest of the shirt as well as the person wearing it. For instance, certain types of collars are more flattering for different types of faces. For this reason, it is said that men with square-shaped faces look best in Standard Point, or Tabbed collars, whereas men with triangular-shaped faces look best in wide or spread collars. Moreover, the color of the collar can also play a role in accentuating the skin tone of a man's face.

Accordingly, many shirt designers make assiduous efforts in the design and shape of the collars to impart their own unique trademark or panache to their respective clothing lines. However, these details are often threatened by a necessity beyond their control: the dry cleaners.

Many dry cleaners employ a conveyor belt system, which pits shirts against each other into an extremely tight space in order to maximize space and to retrieve clothing quicker. Unfortunately, in the process, the shirt collars are often pressed flat, and lose their shape. This loss of shape may greatly attenuate the aesthetic look, which the original designer intended.

As such, what is clearly needed in the art is an improved coat hanger which can help preserve the shape of a dress shirt, be adaptable for use with conveyor belts typically found in many dry cleaning stations, and to alleviate the costs typically associated with plastic collar inserts, as well as the attendant labor costs required to insert those inserts into the shirts.

### SUMMARY

In general, in a first aspect, the Conveyor Belt Coat Hanger for Shirts and other Clothing features a Hook, a First Member, a Second Member, a Third Member, a Collar Bar. Embodiments of the invention may include one or more of the following features: a dry cleaning facility incorporating a conveyor belt. Through the use thereof, a dry cleaning facility can maintain the structural integrity of the collars of the shirts while economizing spatial considerations.

The features and advantages described in this summary and the following detailed description are not all-inclusive. Many additional features and advantages will be apparent to one of ordinary skill in the art in view of the drawings, specification, and claims thereof.

### BRIEF DESCRIPTION OF THE DRAWING FIGURES

FIG. 1 is a plan view of an embodiment.

FIG. 2 is a perspective view of an embodiment.

FIG. 3 is a perspective view of an embodiment.

FIG. 4 is a side elevation view of an embodiment.

FIG. 5 is a side elevation view of an embodiment.

FIG. 6 is a side elevation view of an embodiment.

FIG. 7 is a side elevation view of an embodiment.

FIG. 8 is a side elevation view of an embodiment.

### DETAILED DESCRIPTION

According to an embodiment, a unique Conveyor Belt Coat Hanger for Shirts and other Clothing is provided for the purpose of enabling a dry cleaning facility to ensure that the collars of dress shirts are not crushed. The embodiments are described in enabling detail below.

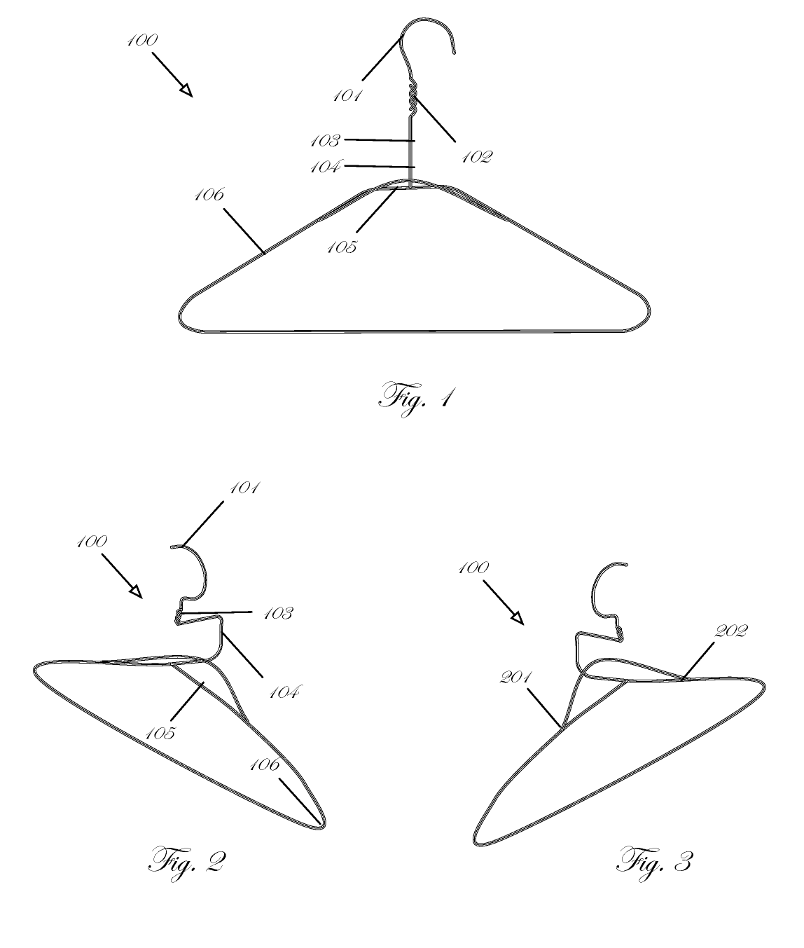

FIG. 1 illustrates that the Conveyor Belt Coat Hanger for Shirts and other Clothing 100 includes a Hook 101, a First Member 102, a Second Member 103, a Third Member 104, a Collar Bar 105, and the coat hanger body 106.

The Hook 101 is used for the purpose of hanging the shirt, and for momentarily placing it on a conveyor belt station typically found in many dry cleaning facilities. As illustrated, the neck region of the coat hanger, which is now comprised by the First Member, the Second Member, and the Third Member has been elongated. This elongation is made in order to lower the shirt so that the Second, Third, and Fourth Members can dovetail into each other thereby reducing the amount of space it would ordinarily take.

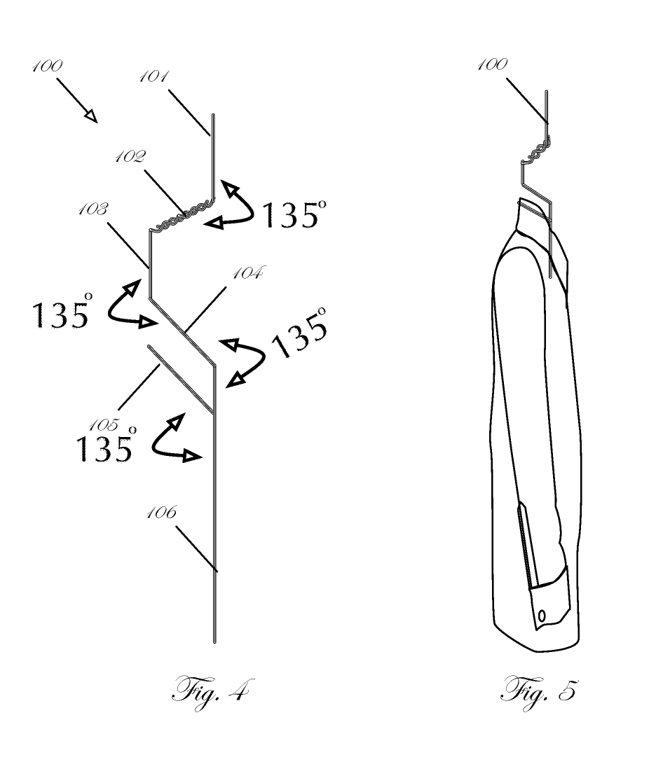

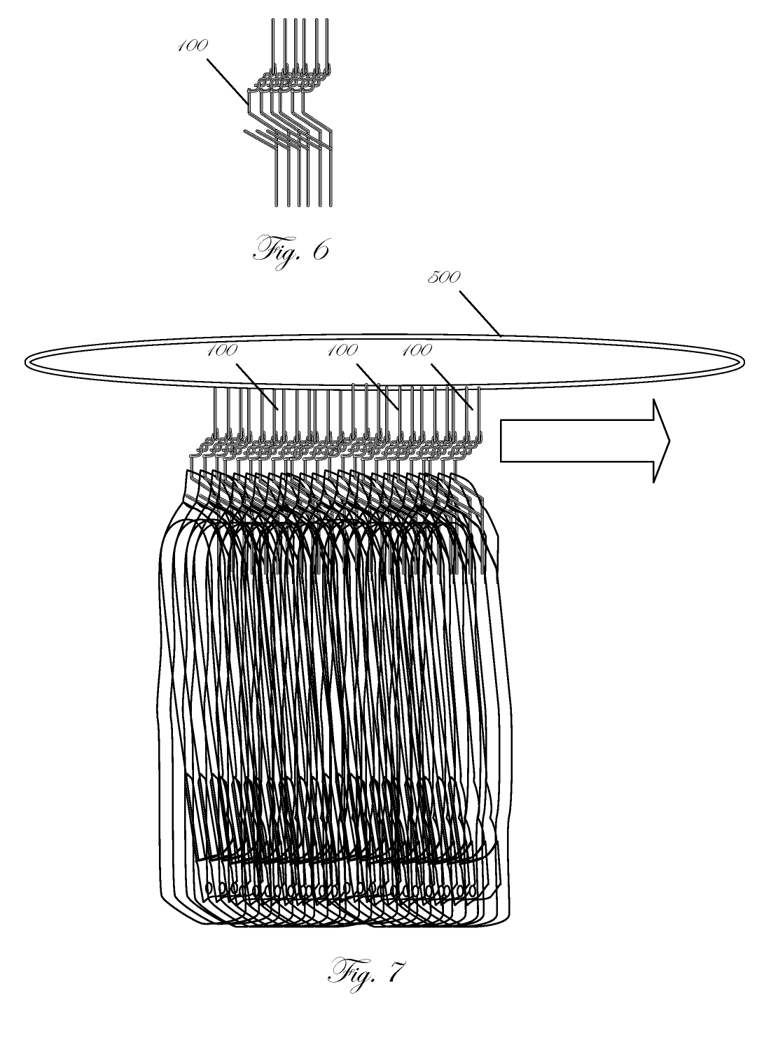

FIG. 4 illustrates that the connections between the hook and the first member, the second member and the third member, and the fourth member and the body are disposed at around 135°. However, it should be noted that other embodiments may diverge widely from this particular angle. For instance, in another embodiment, it may be around 90° as illustrated in FIG. 8.

The Collar Bar 105 is used for the purpose of maintaining the structural integrity of a collar of a shirt. By angling the collar bar at an angle approximating 135° (measured between opposite distal ends of the body), the collar shape will be reinforced as they are placed side by side with respect to other shirts disposed on a conveyor belt as illustrated in FIG. 6. In one embodiment, the Collar Bar 105 has a first distal 201 end and a second distal end 202 disposed on opposite sides of the body. Also, the Collar Bar is connected to an upper portion of the body.

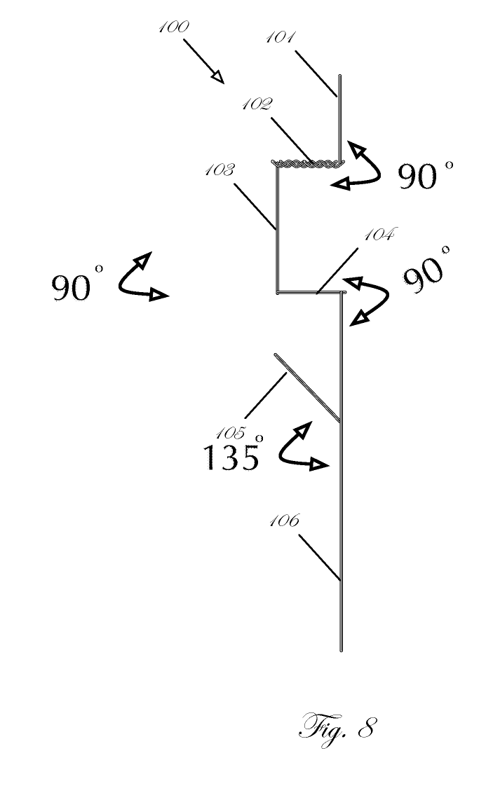

FIG. 7 also illustrates an improved Dry Cleaning Facility or Station wherein the improved coat hanger is used in conjunction with a conveyor belt system 500 to enable a more efficient, and quality control driven operation whereby the shirt collar shapes are maintained.

It will be apparent to the skilled artisan that there are numerous changes that may be made in embodiments described herein without departing from the spirit and scope of those embodiments. As such, the embodiments taught herein by specific examples are limited only by the scope of the claims that follow.

What is claimed is:

1. A Conveyor Belt Coat Hanger for Shirts and other Clothing comprising:
a Body, a Hook, a First Member, a Second Member, a Third Member, and a Collar Bar having a first distal end and a second distal end disposed on opposite sides of the body;
the Hook is connected to the first member;
the First Member is connected to the second member at an angle;
the Second Member is connected to the third member at an angle;
the Third Member is connected to the body at an angle;
and the Collar Bar is connected to an upper portion of the body;
the Collar Bar is disposed at a 135° angle with respect to the body.

2. A dry cleaning facility comprises:
a conveyor belt, and a conveyor belt hanger;
the conveyor belt hanger comprises:
a Body, a Hook, a First Member, a Second Member, a Third Member, and a Collar Bar having a first distal end and a second distal end disposed on opposite sides of the body;
the Hook is connected to the first member;
the First Member is connected to the second member at an angle;
the Second Member is connected to the third member at an angle;
the Third Member is connected to the body at an angle;
and the Collar Bar is connected to an upper portion of the body;
the Collar Bar is disposed at a 135° angle with respect to the body.
whereby a dry cleaning facility can maintain the structural integrity of the collars of the shirts while economizing spatial considerations.
